(19) United States
(12) Patent Application Publication
(10) Pub. No.: US 2010/0014755 A1
(43) Pub. Date: Jan. 21, 2010

(54) SYSTEM AND METHOD FOR GRID-BASED IMAGE SEGMENTATION AND MATCHING

(76) Inventor: Charles Lee Wilson, Darnestown, MD (US)

Correspondence Address: CHRISTIE, PARKER & HALE, LLP, PO BOX 7068, PASADENA, CA, 91109-7068, US

(21) Appl. No.: 12/176,979

(22) Filed: Jul. 21, 2008

(51) Int. Cl. G06K 9/50

(52) U.S. Cl. 382/173

(57) ABSTRACT

A system and method for segmenting an image. The system and method include: imposing a grid having a plurality of grid cells on the image, each grid cell including a respective subimage; extracting image features from each of the plurality of grid cells; classifying the subimages in each grid cell without using geometric information about the image using a trained classification routine; generating classified image segments from the classified subimages; and generating a class map from the classified image segments. Selected features in the generated class map may then be compared with a database of existing images to determine a potential match. The image may be an iris image, a facial image, a fingerprint image, a medical image, a satellite image

### FIELD OF THE INVENTION

The present invention relates generally to image processing; and more particularly to a system and method for grid-based image segmentation.

### BACKGROUND

Generally, image segmentation is the process of partitioning a digital image into multiple regions (sets of pixels). Image segmentation simplifies and/or changes the representation of an image into something that is more meaningful and easier to analyze. Image segmentation is typically used to recognize and/or locate objects and boundaries (lines, curves, etc.) in the image. Typically, the result of image segmentation process is a set of regions that collectively cover the entire image, or a set of contours extracted from the image. Each of the pixels in a region are similar with respect to some characteristic or computed property, such as color, intensity, or texture. However, adjacent regions are significantly different with respect to the same characteristics.

Rule based image segmentation techniques have been extensively used to recognize and/or locate objects in images. However, these techniques have many shortcomings Some of which are described below. Rule based systems use expert knowledge that can be converted to a set of rules in a computer program. The first step in constructing such a program is to get a clear statement of what the rules are. This can present major difficulties when the image set of interest is highly variable or has unknown or mathematically difficult to describe sources of variation. The final rule based system will often not be suitable for the specified application in these cases. This causes rule based systems to be brittle in that when the geometric assumptions and equations used to build them fail these failures are catastrophic. In contrast supervised machine learning systems can incorporate information from examples which cover a broad range of cases using very general set of mathematical procedure.

Therefore, there is a need for an improved image segmentation technique to provide robust segmentation results to classes of widely varying images.

### SUMMARY

In some embodiments, the present invention is a system and method for segmenting an image. The system and method include: imposing a grid having a plurality of grid cells on the image, each grid cell including a respective subimage; extracting image features from each of the plurality of grid cells; classifying the subimages in each grid cell without using geometric information about the image using a trained classification routine; generating classified image segments from the classified subimages; and generating a class map from the classified image segments. Selected features in (various regions of) the generated class map may then be compared with a database of existing images to determine a potential match. The image may be an iris image, a facial image, a fingerprint image, a medical image (such as, X-Rays, CAT Scans, MRI, and the like), a satellite image, and the like.

Classifying the subimages in each grid cell using a trained classification routine may further include: dividing a test image into a plurality of regions; imposing a test grid having a plurality of test grid cells on the test image, each test grid cell including a respective test subimage; assigning a class to each of the plurality of test grid cells in the test grid; extracting image features from each of the plurality of test grid cells; dividing the grid cells with extracted image features into a training set and a verification set; classifying the subimages in each test grid cell of the test grid, without using any geometric information about the subimages; and generating a trained class map with each subimage labeled according to a respective assigned class.

In some embodiments, the present invention is a system and method for segmenting an image. The system and method include: imposing a grid having a plurality of grid cells on the image, each grid cell including a respective subimage; extracting image features from each of the plurality of grid cells; training a classification routine for the subimages using a training set of test grid cells; verifying the trained classification routine using a verification set of test grid cells; classifying the subimages in each grid cell without using geometric information about the image using the verified trained classification routine; generating classified image segments from the classified subimages; generating a class map from the classified image segments; and comparing selected features from (various region) the generated class map with a database of existing images to determine a potential match.

### BRIEF DESCRIPTION OF THE DRAWINGS

FIG. 1 is an exemplary process flow for training of a classification method, according to some embodiments of the present invention;

FIG. 2 illustrates exemplary regions used for an iris image segmentation, according to some embodiments of the present invention;

FIG. 3 shows an exemplary image of an eye;

FIG. 4 shows an exemplary image of an eye;

FIG. 5, depicts an exemplary grid imposed on an exemplary image, according to some embodiments of the present invention;

FIG. 6 depicts an exemplary process flow for image labeling and extraction, according to some embodiments of the present invention;

FIG. 7 shows an exemplary process flow for an exemplary machine learning process, according to some embodiments of the present invention;

FIG. 8 shows an exemplary process flow for an exemplary image segmentation, according to some embodiments of the present invention; and

FIG. 9 shows an exemplary class map according to some embodiments of the present invention.

### DETAILED DESCRIPTION

The present invention is a grid base image segmentation system and method for separating images into different subimage classes. In some embodiments, the system and method make no prior assumptions about the nature of the image, allow human pattern recognition abilities to be applied to the problem using a training set, allow a broad range of supervised pattern recognition techniques to be applied to the segmentation problem, and may be used to evaluate the probability of successful segmentation of each subimage. Although, this document uses iris image segmentation as the primary example for image segmentation, the invention is not limited to iris image segmentation. Rather, the invention is also applicable to other possible applications, for example, facial images, fingerprint images, medical images, satellite images, and the like. In some embodiments, the invention utilizes a neural network with learning capability to perform the image segmentation.

A neural network typically involves a network of simple processing elements (PEs), which are capable of collectively processing complex problems. In a neural network model, simple nodes (PEs) are connected together to form a network of nodes. Typically, a neural network includes algorithms designed to alter the strength (weights) of the connections in the network to produce a desired signal flow. Some neural networks are capable of learning. That is, given a specific task to solve, and a class of functions, learning means using a set of observations, in order to find an optimal solution which solves the task in an optimal way. This entails defining a cost function such that, for the optimal solution, no solution has a cost less than the cost of the optimal solution. The cost function C is an important concept in learning, as it is a measure of how far away one is from an optimal solution to the problem that needs to be solved. Learning algorithms search through the solution space in order to find a function that has the smallest possible cost. For applications where the solution is dependent on some data, the cost must necessarily be a function of the observations. The cost function is typically defined as a statistic to which only approximations can be made.

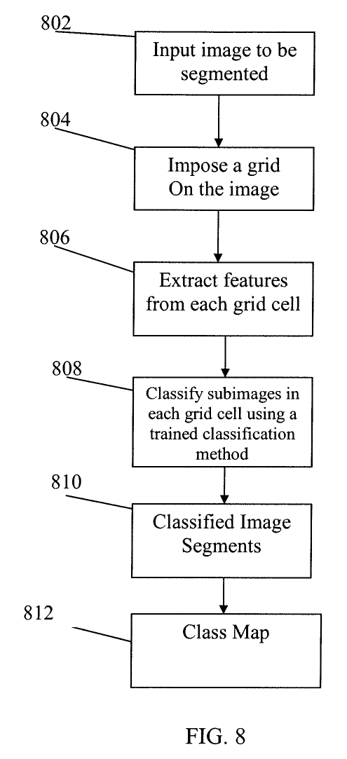

FIG. 8 depicts an exemplary process flow for an exemplary image segmentation, according to some embodiments of the present invention. The image to be segmented, for example, an iris image, a facial image, a fingerprint image, a medical image, or a satellite image, is loaded into the system, as shown in block 802.

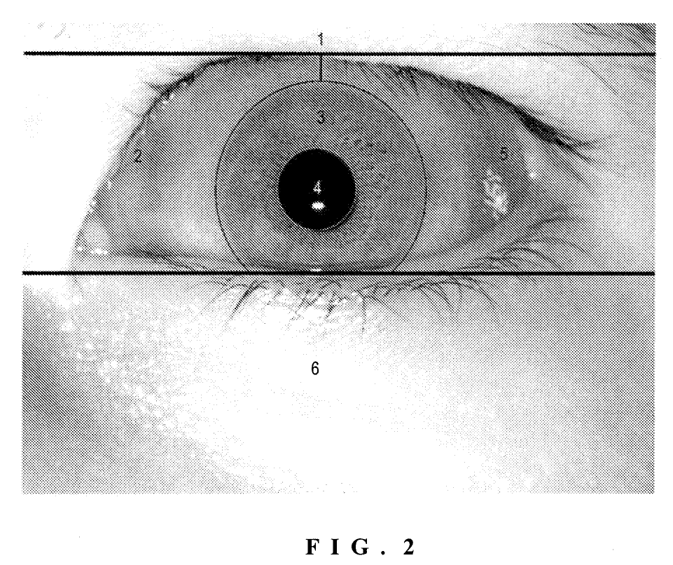

FIG. 2 illustrates exemplary regions used for an iris image segmentation (six regions), according to some embodiments of the present invention. The six exemplary regions used in FIG. 2 are: 1. Above the eye, 2 Left of the iris, 3 Iris, 4 Pupil, 5 Right of the iris, 6 Below the eye. In this example, the boundaries of the regions are straight lines and arcs of circles. However, any curve in the image plane could be used and the regions need not be simply connected. In a case of a fingerprint the image may be divided into regions based on where the ridges and valleys of the fingerprint are best represented. In a case of a satellite image, the image may be divided into, for example, landscapes, roads, building, bridges, rivers, mountains, etc.

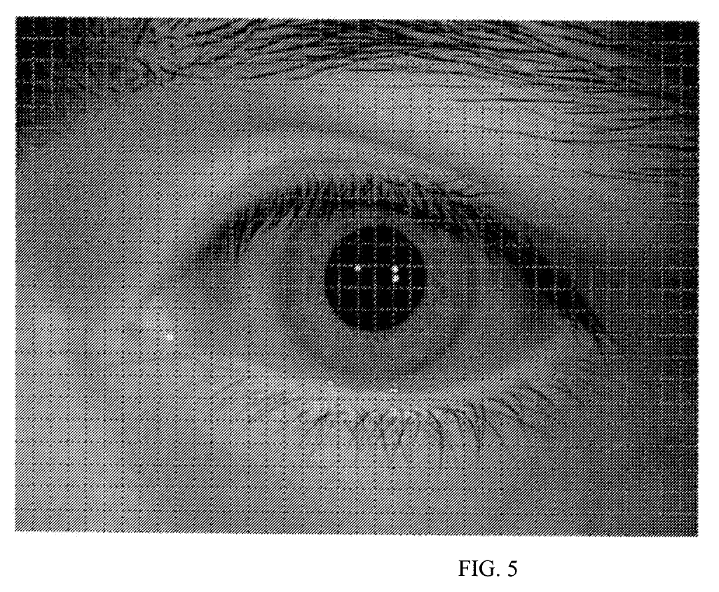

A grid is generated and imposed on the image to divide the image into a number of subimages, as shown in block 804 of FIG. 8. In some embodiments, a square uniform grid is used, as shown in FIG. 5. However, any grid arrangement that covers the entire image plane could be used. The grid is used to generate image features. Each subimage defined by each grid cell (element) is presented to the machine learning process through the features extracted form that subimage. In some embodiments, each set of features is labeled with the same class label as that part of the grid. In some embodiments of the invention, the equations of the lines, circles and arc of circles shown in FIG. 2 are used to label the subimages. As an example, suppose the line above the eye is line y=K. In this case, any grid element that has y coordinates greater than K would be assigned the class “above the eye”. As another example, suppose that the center of the pupil has a x-y coordinates of x1,y1 and that the radius of the pupil is Rp, then any grid element that has a distance from x1,y1 less than or equal to Rp will be assigned to the pupil class.

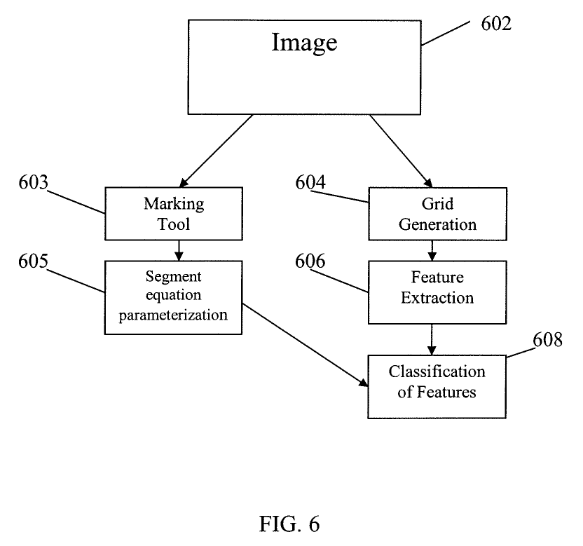

At this time the image is already labeled by a trained classification process, described in detail in blocks 602 and 603 of FIG. 6. The image features are extracted from each grid cell in block 806.

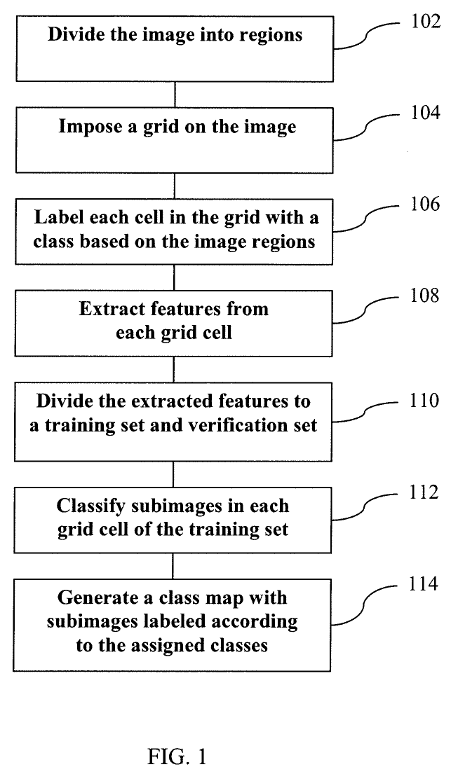

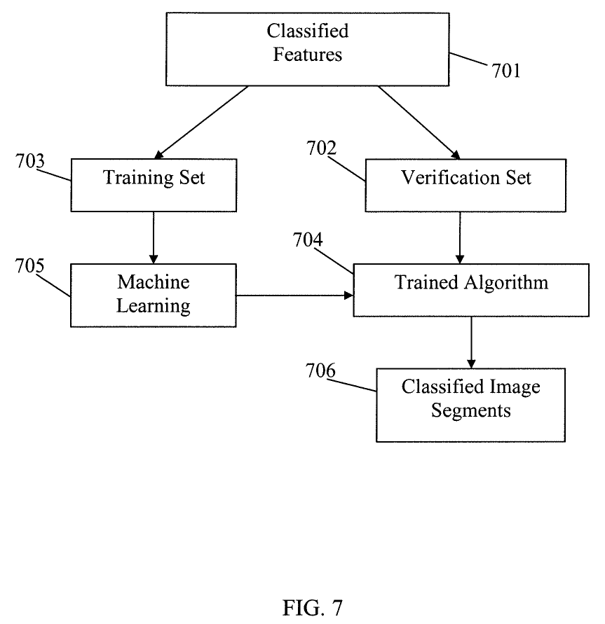

Referring back to FIG. 8, in block 808, the trained algorithm (for example, shown in block 704 of FIG. 7 and described in FIG. 1, below) is used to classify the segments of the image. Since the machine has been trained, this classification is performed without using any geometric information about the images. A class map is then generated from the classified image segments in block 812.

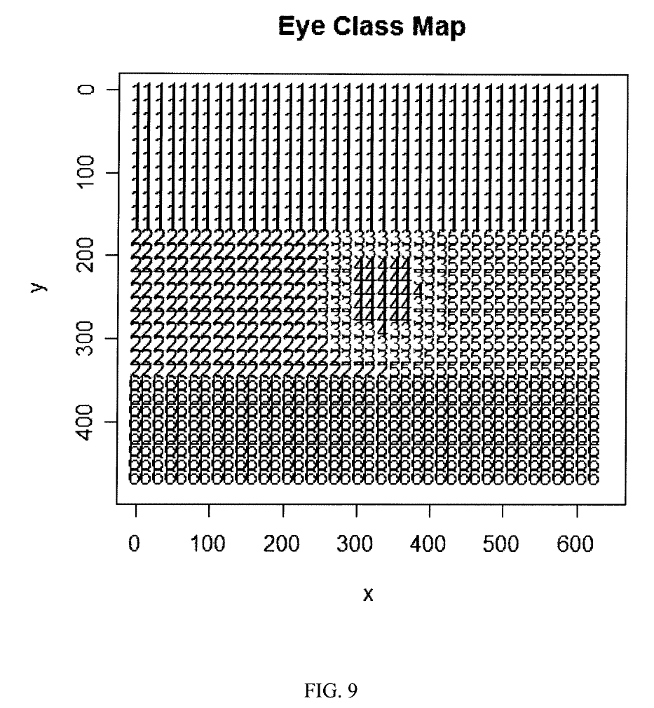

FIG. 9 shows an exemplary class map for an eye, according to some embodiments of the present invention. As shown, 1s are the above the eye class, 2s are the left of iris class, and 3s are the iris class. Additionally, 4s are the pupil class, 5 are the right of iris class, and 6s are the below the eye class. After classification, prior geometric information such as, grid element location may be used to reconstruct the curves used in the image, or grid subimages can be used directly for image recognition. The result is an image where the various subimages are classified in the verification set without any prior labeling.

The class map of the segmented image can then be compared to a database of images for image matching or image recognition. That is, one or more images in the database may potentially be matched by a new set of recognition features extracted from one or more of the class regions. For example, in the case of biometric image (for example, eye iris) recognition, in some embodiments, the recognition process aligns the classified (labeled) biometric subimages and compares them to verify the identity of a person using features from the part of the image classified in the class map as the iris. In some embodiments for iris recognition, the two images to be aligned by the translation so that the centers of the pupils coincide and the images are scaled so that the diameters of the iris are the same.

After segmentation, the grid cells that have been located for matching, for example, the iris cells, are used to obtain features for image matching. In some embodiments, these features are used to compare the irises of two different iris images. This comparison might be made directly, for example using distance measures, other know methods, or another machine learning device might be trained to produce match and nonmatch classifications. In some embodiments of the present invention, these features may be identical to the features used in segmentation. In some embodiments, new features may be calculated to augment or replace the features used in the segmentation.

FIG. 1 is an exemplary process flow for training of a classification method, according to some embodiments of the present invention. The image, for example, an iris image, a facial image, a fingerprint image, a medical image, or a satellite image, is divided into different regions, as shown in block 102. The image may be divided into regions by a human being using a marking tool, by an automated process that recognizes regions of interests in the image, or a combination of both. After the image has been divided into regions and each region has been labeled, a grid is imposed on the image to divide the image (including the regions) into a number of subimages, as shown in block 104. Each cell in the grid is then labeled with a class, which may be determined from the position of each cell in the labeled subimages, as depicted in block 106. This process is similar to that of block 804 of FIG. 8, described above.

In block 108, image features used for machine learning are extracted from each grid cell. In some embodiments, the feature extraction process makes no prior assumptions about the contents of each cell subimage. These features are then sent to a machine learning process such as, a neural network. In some embodiments of the invention, this functionality is identical to the feature extraction functionality in block 806 of FIG. 8, described in more detail with respect to block 606 of FIG. 6. The extracted features from each cell (of as many images that are required to provide good generalization) are then divided into a training set and a verification set in such a way that the position of no grid cell is represented in both sets, as shown in block 110. This division may be done randomly using a random number generator or may be based on other characteristics of the classified features such as prior class probabilities. The machine learning process learns to classify grid subimages from the training set without using any geometric information about the images, as illustrated in block 112. In block 114, a trained class map with subimages labeled according to the classes is generated. The trained class map provides a tool for geometric evaluation of different learning algorithms. An exemplary class map is depicted in FIG. 9. The trained class map is then used to verify and fine-tune the trained classification method through, for example, manual inspection, automated comparisons using known statistical method, or a combination thereof. These comparisons are made on a class by class basis in each grid cell and use only the class results from the machine learning process and the classes generated by the trained machine learning algorithm. As described above, the trained classification method is then used to classify and then segment other images.

In some embodiments, human experts use a marking tool for class determination of the training and verification sets. In some embodiments, however, the method of class determination is applied before the segmentation device is trained rather than as a test procedure after the device is trained. The skills of human pattern recognition ability and experience can be passed on to the machine learning process in the form of human generated classifications in the training set. Each part of the image to be segmented is assigned a class, which in the iris segmentation case, may be just the name of that part of the eye. As an example, all points in the part of the image containing the pupil are class “pupil’ and are assigned a class designated by the number 4. If the points in a subimage are class 4 the subimage is class 4.

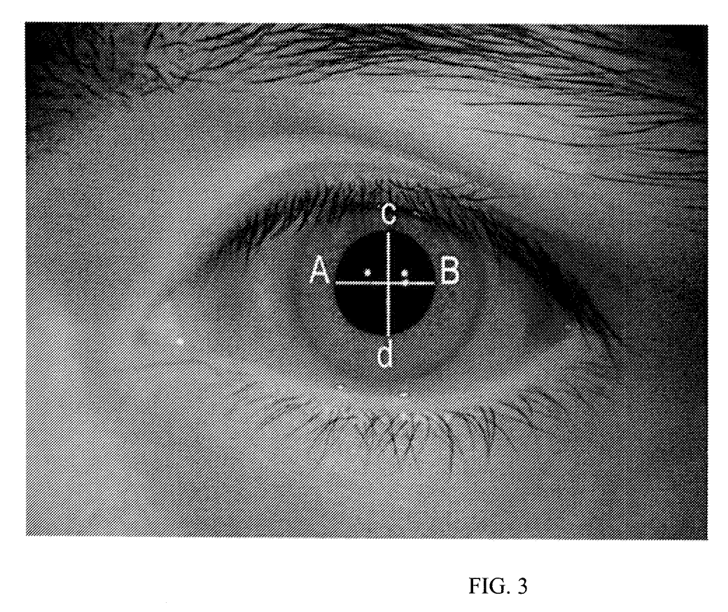

In some embodiments, the class determination is made using a graphics based marking tool, which in the example of FIG. 2, allows the user to position the lines in FIG. 2 for the best possible segmentation, for instance, based on human visual recognition. For example in FIG. 2, the user can move the selected center of the eye right and left and up and down. The user can also expand and contract the radii of the pupil and iris. Finally the user can move the top and bottom lines up and down. More sophisticated classification methods can be used to produce a more complex class map. For example, in FIG. 3, the points where the eyelash intersects the iris near A could individually be assigned a class called “eyelash” and removed from the iris and above the eye classes. As an alternative, or in addition to the previously-described methods, required segment boundaries may be obtained from an automated tool and segment positions be modified for more accurate representation using a marking tool.

FIG. 6 depicts an exemplary process flow for image labeling and feature extraction, according to some embodiments of the present invention. In block 602, an image is read by a marking tool and grid classification process is initiated. The image is then sent to the grid generation process, as shown in block 604 and to the marking tool, as shown in block 603. The marking tool takes user input and sends this input to the segment equation parameterization, as shown in block 605. As an example, if a user using the line above the eye from y=K1 to y=K2, this is recorded and utilized to make all grid cells between K1 and K2 change class. As another example, if the radius of the pupil changes from R1 to R2, grid cells are exchanged between the pupil and iris classes depending on whether R1>R2. The grid is also used as input to the feature extraction, as shown in block 606.

The outputs of the segment parameterization from block 605 in the form of segment boundary equations, such as y=K1, and the feature extraction are then combined to produce classified features, as shown in block 608. In some embodiments, each grid cell is converted into intensity and FFT (Fast Fourier Transform) features. In some embodiments, each subimage is used to generate two sets of feature vectors (for example a 256 bytes long vector). The first feature vector set is made up of copies of the subimage bit maps extracted as vectors. The second feature vector set is made up of copies of the Fast Fourier Transforms (FFTs) of the subimage bit maps extracted as vectors. There may be other ways to extract features beside using FFT transforms. In some embodiments, the present invention may utilize intensity statistics such as mean or median for each cell, or other kinds of transforms such as, wavelet transforms, or Gabor transforms. Although, Fourier and Gabor transforms are two examples of types of basis sets to reconstruct the image, other transforms such as wavelets could also be used. Any basis set that could be used to reconstruct the image is a potential feature set for the present invention. Further, any complete basis set that could be generated and used to reconstruct the image could be used as the basis for an alternate feature set.

The training of the neural network (or Support Vector) machine is based on optimization of an error function which is computed from the difference between the desired classifications input with the training set features and the output of the neural network for these features. In some embodiments, the grid cells coordinates are not passed to the machine learning algorithm. In some embodiments, a trained learning process is then used to classify subimages. The output of the trained machine learning device is used to classify verification images from the features. The grid cell (subimage) coordinates are the position on the original image of the subimages. If these positions were passed, the machine learning process would learn information about the relative position of the subimages in different images classes. This would cause the trained machine learning algorithm to have scale and position information encoded in the algorithm. This information encoding would reduce the scale a positional independence of the algorithm. Scale and positional independence are typically needed to accommodate images that are not centered in the field of the imaging device or taken at variable distances from the imaging device.

FIG. 7 depicts an exemplary process flow for an exemplary machine learning/training process, according to some embodiments of the present invention. The classified features enter the machine learning process, as shown in block 701. The features are split into a training set (shown in block 703) and a verification set (shown in block 702). The training set is used to perform machine learning/training, as shown in block 705. The trained machine learning algorithm is then combined with the verification set in block 704 to test the probable accuracy of the machine learning and produce a verified trained algorithm. In other words, the machine learning device is then tested by comparing the result of the verification set classes to the verification set classifications provided as input. If the trained machine needs any fine-tuning, it is performed to enhance the trained machine. Once the machine is trained and verified, the subimages are classified, as shown in block 706. This trained algorithm is then used in block 112 of FIG. 1 to classify the image.

The grid based image segmentation method and system of the present invention can be implemented using a wide range of machine learning techniques. It is also possible to use or combine multiple techniques to improve accuracy. The present invention is not limited to any particular machine learning technique and is capable of working with a variety of different techniques.

In some embodiments, each subimage is used to generate two sets of feature vectors (for example a 256 bytes long vector). These feature vector are used for training the machine learn algorithm, testing the machine learning algorithm, and segmenting images as shown in blocks 705, 704 of FIG. 7, block 808 of FIG. 8, and block 112 of FIG. 1. In some embodiments, the first feature vector set is made up of bytes extracted from the subimage bit maps stored as vectors. The second feature vector set is made up of copies of the Fast Fourier Transforms (FFTs) of the subimage bit maps stored as vectors. These two sets of feature vectors are then analyzed using, for example, by a principal component analysis (PCA) package, to determine the effective size of the feature sets size. For example, 95%, 98%, and 99% of the variance of each type of feature set are compared for their ability to provide input to the machine leaning.

For some embodiments, the PCA analysis of the iris image data indicates that for 95% capture of the image feature variance could achieved using the first 6 eigenvectors and that 95% of the FFT feature variance could be captured using the first 18 eigenvectors. The number of test vector eigen vectors is kept constant for testing, training, and subsequent recognition. This allowed the 256 image-feature to be transformed, using the discrete Karhunen Loéve (K-L) transform, to 6 features. By rotating the feature vectors into the directions of maximum lineally independent variance, the PCA analysis can be used to reduce the size of the feature set from 512 bytes per subimage to 24 bytes per subimage. A discrete Karhunen Loéve (K-L) transform process is describes in K. Fukunaga, Statistical Pattern Recognition, Morgan Kaufmann, New York, 1990, kNN, the entire contents of which is hereby incorporated by reference.

In some embodiments, the 256 FFT-features are reduced to 18 features using a second K-L transform. The numerical efficiency and speed of calculation of the classifiers and the condition number of many of the covariance matrices of the features is improved by reducing the number of features and concentrating the variance in this smallest possible number of features.

As an example, a k nearest neighbor classifier (kNN) assign classes to any pattern it classifies by assigning the class of those pattern that are nearest to it in features, for example, for k=1, this is just the nearest neighbor. For the kNN classifier, reduction in the size of the feature vectors improves classification time with no loss of accuracy. The discrete K-L transform, mentioned above, provides an effective means of reducing the size of the feature vectors.

In some embodiments, machine learning is used to classify the subimages. Typically, machine learning is concerned with the design and development of algorithms and techniques that allow computers to “learn”. In some embodiments, supervised learning is used for machine learning. In supervised learning, a machine learns to classify data using a technique for learning a function from training data. The training data includes pairs of input objects (typically vectors), and desired outputs. The output of the function can predict a class label of the input object (called classification). The task of the supervised learner is to predict the value of the function for any valid input object after having seen a number of training examples (i.e. pairs of input and target output). These input are called the training set. To achieve this, the learner has to generalize from the presented data to unseen situations in a “reasonable” way.

In various embodiments of the present invention, different machine learning algorithms may be used for iris segmentation. For example, k neatest neighbor (kNN) explained in K. Fukunaga, Statistical Pattern Recognition, Morgan Kaufmann, New York, 1990, kNN [3], and T. M. Cover and P. E. Hart, “Nearest neighbor pattern classification,” IEEE Transactions on Information Theory, 13, pp. 21-27 [4]; neural networks (NN) [5,6], explained in T. Haste, R. Tibshirani, and J. Friedman, The Elements of Statistical Learning, Springer, New York, 2001 [5], and B. D. Ripley, Pattern Recognition and Neural Networks, Cambridge University Press, 1996 [6]; support vector machines disclosed in (SVM) [2], and [5]; and partitioning trees (Rpart) explained in Venables, W. N. and Ripley, B. D, (2002), Modern Applied Statistics with S, Fourth edition Springer [2]; the entire contents of which are hereby expressly incorporated by reference.

The k nearest neighbor method is discussed in detail in [3,4]. K nearest neighbor methods have been shown to be Bayes optimal in [4] for large number of prototypes for k=1. However, the run time of kNN is O(\n\\D\) where N is the number of feature vectors and D is the dimension of the feature vector. This algorithm still provides an estimate of how difficult the problem is and so is worth testing and may be useful for solving difficult segmentation problems. Since kNN is only sensitive to feature vectors, it is also a valuable tool for feature vector selection. Testing various values of k, the number of neighbors, indicated that the classification surfaces were sufficiently complex that k=1 was optimal.

Another exemplary algorithm utilized by the method and system of the present invention is a weighted neural network. Weights are used to partially compensate for the unequal distribution of class samples that is caused by the large area difference between the class regions. The weighting procedure may be less effective than adjusting the number of training samples by class to achieve more equal error distributions between classes.

Another exemplary algorithm utilized is SVMs (as described in [2,5]). In some embodiments of the present invention, only two classes are uses. Two class tests were conducted on an iris segmentor that had class iris (+1) and class not-iris (−1). The results produced by SVM can be used to augment the results of other classification methods.

Another exemplary algorithm utilized is a regression tree-partitioning algorithm discussed on pages 258-269 of [2]. This algorithm has two advantages that make it worth testing. First, it produces a classification tree that can be understood by a human. Second, the tree is usually simple enough so that computationally it would be easy to program and be capable of fast execution. Since the class separation surfaces are hyperplanes, one would expect less accuracy from this algorithm than the nonlinear methods discussed above.

The accuracy of each of the above algorithms is dependent on the data input to the machine learning process, that is, the training set. This is a characteristic of machine learning in general that makes the class output of the marking tool doubly important. The better the training set, the more productive machine learning will be.

A verification test set is used to check the accuracy of the machine learning different algorithms. The verification test set is a sample of data with statistically similar properties to the training set that can be used to check the ability of the machine learning algorithm to classify pattern that have not been previously used to train the algorithm. This ability to classify new patterns is called generalization. Two important characteristics of the verification set are the data not duplicate training examples and that it be statistically similar to the training set. The testing and verification data sets should also be representative of as large a cross section of the sensor image data as possible so that the generalization achieved will allow the invention to perform classification of the subimages as accurately as possible.

In order to produce the simplest possible generalization from the training algorithm that correctly duplicates the verification data when trained on the training data the machine learning algorithm sometimes requires tuning. Algorithm tuning involves careful selection of the training set, verification set, feature set size, and machine learning algorithm parameters.

Furthermore, to achieve generalization across multiple eyes, in some embodiments the method and system of the present invention uses a K-L transform that retains approximately 99% of the original feature set variance has proved to be optimal. In the case of a neural network, the optimal network has a size of the hidden layer is 0.125 times the size of the input layer. This approximate size of network is also helpful for good generalization.

Another advantage of a neural network pattern recognition device, as opposed to rule based methods usually used for segmentation, is that the neural network produces a continuous output which can be used to adjust the acceptance criteria of the segmentor. This is done by adjusting the neural network threshold of the output layer to trade off true match rate against false match rate. In pattern recognition systems that have a continuous output (like neural networks) the level of output signal that constitutes a valid response can be adjusted to insure a reliable result. In a neural network this is done by modifying the output threshold. This increases the probability of a correct response but also increases the probability of a negative or no decision response.

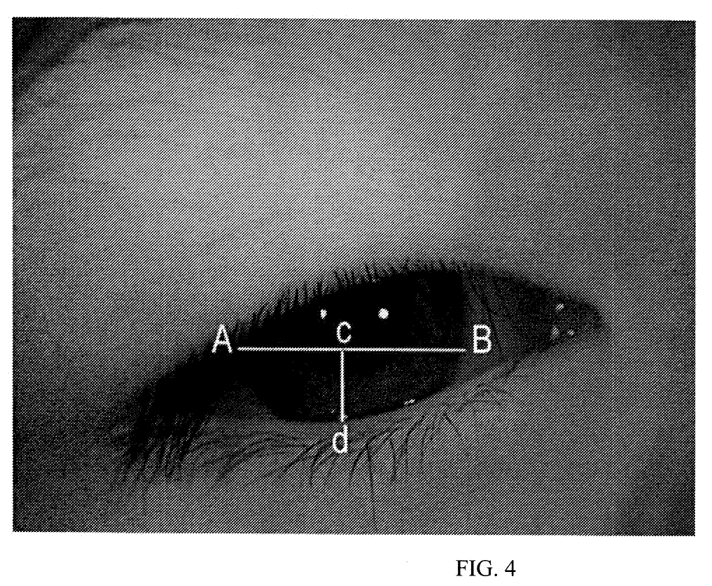

Utilizing a neural network for image segmentation makes detection of poor quality images much easier. For example, if a neural network has been tested on the verification set to produce 90% accuracy for pupil segmentation is applied to an image and no pupil subimages are found the odds are 9 to 1 that the pupil is obscured. Suppose the pattern recognition device is trained on images that look like the example A shown in FIG. 3. The device is then shown an image that looks like the one depicted in example B in FIG. 4. The pattern recognition device may determine that there are no subimages in B that are part of the pupil because it is obscured by the eyelash. We can now base our segmentation of B, with 90% confidence of being correct in the result that the pupil does not show in image B. As another example, if the horizontal extent (shown in example B, as line AB) of the iris subimages is twice the vertical extent (shown as line cd in example B), then the top half to the eye, shown as the part of the eye above AB in example B, is blocked.

In some embodiments, the position of the various subimage grid cells can also be combined with rule based methods to fit the subimage grid cells to the equations used in the marking tool. As an example, the average vertical and horizontal values of the pupil subimages can be used, shown respectively as AB and cd in example A, to locate the center of the eye if the pupil is fully visible.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims.

What is claimed is:

1. A method for segmenting an image, the method comprising:
imposing a grid having a plurality of grid cells on the image, each grid cell including a respective subimage;
extracting image features from each of the plurality of grid cells;
classifying the subimages in each grid cell without using geometric information about the image using a trained classification routine;
generating classified image segments from the classified subimages; and
generating a class map from the classified image segments.

2. The method of claim 1, further comprising comparing selected features in the generated class map with a database of existing images to determine a potential match.

3. The method of claim 1, wherein the image is one or more of the group consisting of an iris image, a facial image, a fingerprint image, a medical image, and a satellite image.

4. The method of claim 1, wherein the extracting image features further comprises:
converting each grid cell into intensity and Fast Fourier Transform (FFT) features; and
generating two sets of feature vectors for each subimage, wherein a first feature vector set includes copies of subimage bit maps extracted as vectors, and a second feature vector set includes copies of the Fast Fourier Transforms (FFTs) features of the subimage bit maps.

5. The method of claim 1, wherein the extracting image features further comprises:
converting each grid cell into intensity and Gabor transform features; and
generating two sets of feature vectors for each subimage, wherein a first feature vector set includes copies of subimage bit maps extracted as vectors, and a second feature vector set includes copies of the Gabor transform features of the subimage bit maps.

6. The method of claim 1, wherein the classifying the subimages in each grid cell using a trained classification routine further comprises:
dividing a test image into a plurality of regions;
imposing a test grid having a plurality of test grid cells on the test image, each test grid cell including a respective test subimage;
assigning a class to each of the plurality of test grid cells in the test grid;
extracting image features from each of the plurality of test grid cells;
dividing the grid cells with extracted image features into a training set and a verification set;
classifying the subimages in each test grid cell of the test grid, without using any geometric information about the subimages; and
generating a trained class map with each subimage labeled according to a respective assigned class.

7. The method claim 6, further comprising verifying features of the trained class map against the test image.

8. The method claim 6, further comprising utilizing the verification set to verify the trained classification routine.

9. The method claim 8, further comprising fine-tuning the trained classification routine using the verification set.

10. The method claim 1, further comprising extracting features from one or more regions of class map and comparing the extracted features to a database of images for image recognition.

11. The method claim 1, further comprising extracting features from one or more regions of the class map and matching the extracted features to a database of images features for image matching.

12. The method claim 11, wherein the image is an iris image, the method further comprising aligning the classified subimages with a plurality of stored subimages to verify identity of a person using features from the part of the image classified in the class map as iris.

13. A system for segmenting an image comprising:
means for imposing a grid having a plurality of grid cells on the image, each grid cell including a respective subimage;
means for extracting image features from each of the plurality of grid cells;
means for classifying the subimages in each grid cell without using geometric information about the image using a trained classification routine;
means for generating classified image segments from the classified subimages; and
means for generating a class map from the classified image segments.

14. The system of claim 13, further comprising means for comparing selected features in the generated class map with a database of existing images to determine a potential match.

15. The system of claim 13, wherein the image is one or more of the group consisting of an iris image, a facial image, a fingerprint image, a medical image, and a satellite image.

16. The system of claim 13, wherein the means for classifying the subimages in each grid cell using a trained classification routine further comprises:
means for dividing a test image into a plurality of regions;
means for imposing a test grid having a plurality of test grid cells on the test image, each test grid cell including a respective test subimage;
means for assigning a class to each of the plurality of test grid cells in the test grid;
extracting image features from each of the plurality of test grid cells;
means for dividing the grid cells with extracted image features into a training set and a verification set;
means for classifying the subimages in each test grid cell of the test grid, without using any geometric information about the subimages; and
means for generating a trained class map with each subimage labeled according to a respective assigned class.

17. The system of claim 16, further comprising means for verifying features of the trained class map against the test image.

18. The system of claim 17, further comprising fine-tuning the trained classification routine using the verification set.

19. The system claim 13, further comprising extracting features from one or more regions of the class map and matching the extracted features to a database of images features for image matching.

20. A method for segmenting an image, the method comprising:
imposing a grid having a plurality of grid cells on the image, each grid cell including a respective subimage;
extracting image features from each of the plurality of grid cells;
training a classification routine for the subimages using a training set of test grid cells;
verifying the trained classification routine using a verification set of test grid cells;
classifying the subimages in each grid cell without using geometric information about the image using the verified trained classification routine;
generating classified image segments from the classified subimages;
generating a class map from the classified image segments; and
comparing selected features from the generated class map with a database of existing images to determine a potential match.

21. The method of claim 20, wherein the image is one or more of the group consisting of an iris image, a facial image, a fingerprint image, a medical image, and a satellite image.
